(19) United States
(12) Patent Application Publication
(10) Pub. No.: US 2026/0090505 A1
(43) Pub. Date: Apr. 2, 2026

(54) BALER

(71) Applicant: MASCHINENFABRIK BERNARD KRONE GMBH & CO. KG, SPELLE (DE)

(72) Inventors: TONY VAN DEN HURK, LIESHOUT (NL); MAIK KUHMANN, GRONAU (DE)

(73) Assignee: MASCHINENFABRIK BERNARD KRONE GMBH & CO. KG, SPELLE (DE)

(21) Appl. No.: 19/339,322

(22) Filed: Sep. 25, 2025

(30) Foreign Application Priority Data
Oct. 1, 2024 (DE) 10 2024 128 473.0

(51) Int. Cl. A01F 15/08; A01F 15/14

(52) U.S. Cl. CPC A01F 15/0858; A01F 15/145

(57) ABSTRACT

A baler includes a pressing channel where crop bales are conveyable along a pressing axis, and a binding arrangement. The binding arrangement has a needle swing, a holding unit, a deflection drive, and a deflection device which has a detection element. The needle swing has binding needles arranged offset to each other. Each binding needle guides a respective binding element strand upwards through the pressing channel. The holding unit holds a holding section of the binding element strand which is guided upwards. The deflection drive adjusts the deflection device. The detection element moves relative to the holding unit and partially moves along the pressing axis. At least one binding element strand is detectable by the detecting element, and is deflected through the pressing channel to produce a binding element loop. The binding element loop changes direction relative to the pressing axis at the at least one detection element.

### CROSS REFERENCE TO PRIOR APPLICATIONS

Priority is claimed to German Patent Application No. DE 10 2024 128 473.0, filed Oct. 1, 2024. The entire disclosure of said application is incorporated by reference herein.

### FIELD

The present invention relates to a baler and to a method of operating the baler.

### BACKGROUND

Balers are used in agriculture to compress crops such as previously collected hay or straw into bales. The crop is usually collected from the ground by a pick-up that is integrated into the baler. In the case of a square baler, the collected crop is compressed in two stages. The crop is first picked up by the pick-up and, if necessary, cut by a cutting device, and is conveyed by a conveyor device or collecting device within a collecting chamber, where it is gathered and pre-compacted. The collecting chamber is followed by a pressing chamber or a pressing channel. An oscillating press piston there acts on the crop and carries out the actual pressing. Pre-compacted crop is thus transferred in portions into the pressing channel where the square bale is successively built up.

When the square bale has reached a specified size, the square bale is tied via a binding material or binding element before being ejected. The binding element can, for example, be a yarn or a thermoplastic tape. During the binding process, one end area of the binding element is held in place at the upper side by a holding device, wherein the binding element strand is guided along the upper side to the rear end, then downwards and finally back to the front underneath the bale. A subsequent section of the binding element strand is guided by a binding needle. To complete the binding process of one bale and to start the binding process of a subsequent bale, binding needles are guided through the pressing channel from below and each transfers a section of a binding element strand to a holding device. This can be connected to the held end area, either by knotting or welding, to form a closed loop around the bale.

As the bale successively grows, the loop that is still open and in the process of forming must also grow. More of the binding element is in particular needed gradually towards the upper side of the bale. This is achieved by pulling the binding element strand held by the holding device upwards through the pressing channel at the rear of the bale. The bale being formed is, however, in contact with the last bale that was completed but not yet ejected. The latter forms an abutment which supports or enables the pressing of the subsequent bale. Due to the contact pressure acting between the bales, the binding element strand is subject to increased friction, which in turn affects the required pulling force. Friction increases sharply in particular when the press piston is used intermittently. High stress is thus imposed on the binding element strand, which in the worst case can cause it to break.

### SUMMARY

An aspect of the present invention is to reduce the load on the binding element when forming a crop bale, in particular during compaction.

In an embodiment, the present invention provides a baler which includes a pressing channel which is configured so that crop bales are conveyable from a front to a rear along a pressing axis relative to a longitudinal axis, and a binding arrangement. The binding arrangement comprises a needle swing, at least one front holding unit, a deflection drive, and at least one deflection device. The needle swing comprises a plurality of binding needles which are arranged offset relative to each other with respect to a transverse axis. Each of the plurality of binding needles is configured to guide a respective binding element strand upwards through the pressing channel relative to a vertical axis. The at least one front holding unit is configured to hold a first holding section of the binding element strand which is guided upwards through the pressing channel by a binding needle of the plurality of binding needles. The at least one deflection device comprises at least one detection element. The at least one deflection device is configured to be adjusted by the deflection drive from a standby position into a deflection position. The at least one detection element is configured to be movable relative to the at least one front holding unit and to be movable at least partially along the pressing axis. At least one binding element strand is arranged to be detectable by the at least one detecting element at a distance from the first holding section, and to be deflected relative to the front holding unit so as to draw the at least one binding element strand through the pressing channel so as to produce a binding element loop which runs from the front holding unit via the detection element. The binding element loop has a change of direction relative to the pressing axis at the at least one detection element.

### BRIEF DESCRIPTION OF THE DRAWINGS

The present invention is described in greater detail below on the basis of embodiments and of the drawings in which:

FIG. 1 shows a perspective illustration of a part of a baler according to the present invention;

FIGS. 2A-2C show side views of a part of the baler from FIG. 1 in various states during a binding cycle;

FIGS. 3A-3E show side views of a part of the baler from FIG. 1 in various states during the formation of a binding element loop;

FIG. 4 shows a perspective illustration of parts of a binding arrangement and a knotter table of the baler;

FIG. 5 shows a perspective illustration of a deflection device of the binding arrangement;

FIG. 6 shows a highly schematic side view of part of a second baler according to the present invention;

FIG. 7 shows a highly schematic side view of part of a third baler according to the present invention; and

FIG. 8 shows a highly schematic side view of part of a fourth baler according to the present invention.

### DETAILED DESCRIPTION

The present invention provides a baler with a pressing channel in which crop bales can be conveyed from front to rear along a pressing axis relative to a longitudinal axis, and with a binding arrangement comprising a needle swing with a plurality of binding needles arranged offset relative to each other about a transverse axis, each of which binding needles is designed to guide a binding element strand upwards through the pressing channel relative to a vertical axis, and at least one front holding unit which is designed to hold a first holding section of a binding element strand guided upwards through the pressing channel by the binding needle.

The baler is usually a square baler or large square baler. The baler can be self-propelled with its own power drive or designed as a trailer without its own power drive. The baler can also be a stationary baler. The baler has a pressing channel and a binding arrangement, wherein the term “binding arrangement” should not here be interpreted restrictively. Not all elements and parts of the binding arrangement in particular necessarily serve for binding in the narrower sense.

The actual bale formation and pressing process take place in the pressing channel. The pressing channel defines a pressing axis to which it can run at least predominantly parallel. Along the pressing axis, in particular parallel thereto, crop bales can be conveyed during operation, which are subsequently referred to simply as “bales.” The pressing channel can, for example, have a rectangular cross-section which corresponds to the cross-section of the crop bales to be produced. A press piston is typically arranged in the pressing channel, the press piston being designed to act on the crop via an oscillating movement parallel to the pressing axis and thus to press it. The action of the press piston compresses the crop and also conveys the crop bale thus formed further relative to a longitudinal axis from front to rear. This means that the intended conveying direction of the crop bales defines the orientations “front” and “rear” here and below. The longitudinal axis as well as the transverse axis and vertical axis mentioned below refer to the axes of the baler. The longitudinal axis, the transverse axis, and the vertical axis are generally perpendicular to each other in pairs. The transverse axis can, for example, be perpendicular to the pressing axis. The longitudinal axis can in particular run horizontally and opposite to a direction of travel of the baler. The transverse axis can in particular run horizontally and transversely to the direction of travel, and the vertical axis can, for example, run vertically. Other courses, however, are also possible and the names of the axes should not be interpreted as restrictive in this respect. One could also generally speak of a first, second and third axis in this respect. The pressing axis in some embodiments can coincide with the longitudinal axis of the baler, but the pressing axis can also be inclined relative thereto. With regard to the crop flow, a collecting chamber is usually installed upstream of the pressing channel in which a conveyor device or a collecting device is set up to portion the crop and to convey it further in portions. The crop is also pre-compacted by the collecting device under certain circumstances.

A binding element is applied inside the pressing channel to secure the shape of the finished bale. The binding element, which can also be referred to as binding material, can be a yarn or a thermoplastic tape (for example, made of PET). The binding element is usually placed around the bale in a plurality of separate loops spaced transversely to the pressing axis. The binding arrangement also and primarily serves to provide the bale with the binding element. An essential component of the binding arrangement is the needle swing, which has a plurality of binding needles arranged offset from each other relative to a transverse axis, each of which is designed to guide a binding element strand upwards through the pressing channel relative to a vertical axis. The respective binding element strand can be taken from a binding element supply, in particular a binding element roll, and guided to the binding needle. The baler can have a system of deflection rollers therefor. The needle swing has a plurality of binding needles which can, for example, be fastened to a common carrier. They are offset from each other relative to the transverse axis. The number of binding needles on the needle swing is generally not limited but can typically be between two and eight. Each of the binding needles can guide a binding element strand through the pressing channel, namely, upwards relative to the vertical axis. The movement of the binding element strand relative to the vertical axis thus defines the direction referred to as “upwards”. This can in particular be a movement against the direction of gravity. The movement of the binding needles and the movement of the binding element strand are, however, generally not parallel to the vertical axis. The respective binding needle guides the binding element strand from the underside of the pressing channel to the upper side, wherein the terms “upper side” and “underside” are to be understood in relation to the “upwards” direction. The needle swing can be pivoted about a swing arm axis that runs parallel to the transverse axis. The present invention is not, however, limited to this embodiment.

The binding arrangement furthermore has at least one front holding unit which is designed to hold a first holding section of a binding element strand guided upwards through the pressing channel by a binding needle. The front holding unit can, for example, have two cooperating retaining elements, at least one of which is movable. The front holding unit is typically controlled via a knotter shaft or a control shaft, which can also control other processes involved in the binding process. The front holding unit can hold a section of each binding element strand, which is here referred to as the “first holding section”. Each binding element strand is regularly assigned a front holding unit, i.e., each holding unit is designed to hold the first holding section of exactly one of the binding element strands. Holding is based on a frictional connection which may be supplemented by a positive fit connection. The holding units in some embodiments can also be referred to as clamping units, and instead of holding, reference can instead be made to clamping. A separating element can be coupled to the front holding unit, which separating element is designed to cut through the binding element strand adjacent to the first holding section. The terms “front holding unit” and “first holding section” are generally only used for conceptual distinction and do not imply that a further (e.g., rear) holding unit and/or a second holding section must necessarily be present.

The first holding section can form the starting point of a new binding loop, which is then placed around a newly formed crop bale as the process continues. Starting from the first holding section, the binding element strand runs downwards through the pressing channel between the newly formed bale and the previous, already bound bale. As the crop bale grows in size, the crop bale's rear end moves further back along the longitudinal axis, wherein part of the binding element strand must extend from the upper side of the newly formed crop bale to the rear end thereof, where the binding element strand then leads downwards between the two crop bales. Since the distance between the front holding unit and the rear end of the crop bale gradually increases, the length of the section on the upper side must also increase over time. Binding elements in the prior art are therefore gradually added between the crop bales. Due to the friction that occurs between the binding element and the crop bales, this places considerable strain on the binding element strand.

The present invention provides that the binding arrangement has at least one deflection device which can be adjusted by a deflection drive from a standby position into a deflection position, whereby at least one detection element of the deflection device, which detection element is movable relative to the front holding unit, is movable at least partially along the pressing axis and at least one binding element strand can be detected by a detection element at a distance from the first holding section and can be deflected relative to the front holding unit in order to draw the binding element strand through the pressing channel and to produce a binding element loop running from the front holding unit via the detection element, which loop has a change of direction relative to the pressing axis at the detection element.

The binding arrangement has at least one deflection device, possibly also a plurality of deflection devices. The deflection drive can be used to drive the deflection device so that it can be moved from a first position, known as the standby position, to a second position, known as the deflection position. The standby position and the deflection position can in particular correspond to the outermost positions of a movement range. Embodiments are also conceivable, however, in which the deflection device can, for example, be adjusted beyond the deflection position. The deflection drive can, for example, be designed as a hydraulic, pneumatic, or electric drive. The deflection drive can, however, also have a spring element, for example, a spring element which was previously tensioned and which causes the deflection device to move when released. The deflection device can be connected directly or indirectly to the deflection drive. The deflection device has at least one detection element, for example, a plurality of detection elements. At least one detection element, for example, each detection element, is movable relative to the front holding unit. The respective detection element can, for example, also be movable relative to a main frame of the baler. By adjusting to the deflection position, at least one detection element of the deflection device that is movable relative to the front holding unit can be moved at least partially along the pressing axis. The movement of the detection element does need not be parallel to the pressing axis, but it does contain a movement component that runs parallel or antiparallel to the pressing axis. This therefore results in a change in position relative to the pressing axis. The direction in which the detection element moves from the standby position to the deflection position is also referred to below as the deflection direction. The deflection direction can be constant along the entire path, however, it can also change. This means that the detection element need not move in a straight line.

Corresponding to the movement of the detection element, at least one binding element strand can be detected by a detection element. At least one detection element can, for example, be assigned to each binding element strand, in particular exactly one detection element. The binding element strand is picked up and deflected at a distance from the first holding section, which is held by the front holding unit. The deflection causes the binding element to be drawn through the pressing channel. The binding element can in particular be pulled through between the crop bale being formed and the already completed crop bale behind it. As a result, a binding element loop is formed, which runs from the front holding unit over the detection element. At the detection element, the binding element loop has a change of direction relative to the pressing axis, i.e., a reversal of direction. This means that the binding element strand runs on the one hand of the detection element in a first direction relative to the pressing axis (for example, to the rear), while on the other hand of the detection element it runs in an opposite second direction relative to the pressing axis (for example, forwards). The binding element strand need not run parallel to the pressing axis. The change of direction can in particular result from the movement of the detection element along the pressing axis, during which the grasped binding element strand is deflected along the pressing axis. It can also be said that the binding element loop runs back and forth relative to the pressing axis. It has at least two loop sections whose positions overlap relative to the pressing axis. The loop sections may, for example, be spaced apart relative to the vertical axis. The binding element loop can have a plurality of changes in direction in some embodiments. The binding element loop provides a binding element supply above the crop bale, which can be used up successively during further bale formation if the crop bale grows as described. As long as the binding element loop is used up, no further binding element need be pulled through the pressing channel, which means that further stress on the binding element strand is avoided. A particularly large binding element loop can be produced due to the at least partial movement of the detection element along the pressing axis. A correspondingly large movement range of the detection element along the pressing axis can be easily achieved in the design without interfering with adjacent binding element strands or with elements of the binding arrangement that are assigned to adjacent binding element strands.

While the binding element loop is being formed and the detection element moves relative to the front holding unit, the binding element strand moves across the detection element, i.e., the detection element comes into contact with different areas of the binding element strand in succession. It is possible for the binding element strand to slide along the detection element. To minimize frictional forces and possible stress on the binding element strand, the detection element can, for example, be mounted on a rotatable bearing. It can, for example, be designed as a roller or cylinder. The rotation axis advantageously runs perpendicular to the deflection direction. It can in particular run parallel to the transverse axis.

Once the binding element loop has been created, it is gradually again used up. The binding element loop is designed to form a binding element section, in particular arranged above the current crop bale, when forming the current crop bale by using up the binding element loop. The use of the binding element loop would be made more difficult or impossible if the detection element remained in the deflection position and continued to hold the binding element strand. This means that the binding element loop must again be released after it has been created. This can be achieved in different ways, for example, by allowing the detection element to progressively yield, furthermore, however, keeping the binding element strand under tension. It would, however, be difficult to coordinate the movement of the detection element with the growth of the crop bale. It would also be possible for the detection element to be mechanically decoupled from the binding element strand in the deflection position, however, this would require a corresponding mechanism for decoupling. The binding arrangement can, for example, be designed to release the binding element loop after the binding element loop has been produced by returning the deflection device to the standby position. This means that after the binding element loop has been produced, the deflection device is moved back from the deflection position to the standby position. This can occur immediately after reaching the deflection position or with a delay. The adjustment speed can be selected differently. The deflection device must at the very least be back in the standby position in good time when the next crop bale is formed. The speed should also be high enough to relax the binding element loop. The deflection drive can be used to move the door to the standby position. If the deflection drive has a spring element (as mentioned above), either the return to the standby position can be performed by a motor, wherein the spring element is tensioned, or the adjustment to the deflection position can be performed by a motor, wherein the spring element is tensioned in order to subsequently be able to effect the return to the standby position.

The binding arrangement is advantageously designed to produce the binding element loop with a maximum total length which corresponds to at least 20%, for example, at least 40%, and, for example, at least 60% of a length of a completed crop bale in the direction of the pressing axis. As the crop bale grows, the binding element loop is gradually used up and ultimately forms at least part of the binding element section extending parallel to the pressing axis on the upper side of the crop bale. Its length is identical to the length of the crop bale. The maximum total length of the binding element loop is the greatest length that the binding element loop temporarily reaches. This can in particular be achieved if the deflection device has just reached the deflection position. The total length to be measured is from the front holding unit, via the detection element, to the point where the binding element strand reaches the front of the last completed crop bale. The total length should be such that the binding element loop is present at least during a sufficiently long initial phase of bale formation. At least 20% of the bale length is reasonable in this respect, wherein larger values can, for example, be used. In order to achieve such a total length, a deflection distance traveled by the detection element between the standby position and the deflection position can correspond to at least 10%, at least 30%, or at least 50% of the length of the crop bale.

The detection element can, for example, be at least partially movable in a deflection direction which runs at least predominantly at an angle of at most 30° to the pressing axis. The angle can in particular be a maximum of 20° or a maximum of 10°. The deflection direction thus runs approximately parallel to the pressing axis. It can, for example, run parallel to the pressing axis. “At least predominantly” means that this applies to the majority (over 50%) of the adjustment range between the standby position and the deflection position. This can in particular apply continuously, i.e., for the entire adjustment range. This means that when adjusted, the detection element is moved almost parallel or almost antiparallel to the direction of movement of the crop bales within the pressing channel. This can thus allow a large binding element loop to be produced without requiring much space in the direction of the vertical axis. Further advantages arise when the deflection direction is directed to the rear, i.e., at least approximately parallel to the direction of movement of the crop bales. This will be explained in more detail below.

Rotary adjustment of the detection element between the standby position and the deflection position is in principle conceivable, for example, by pivoting. This generally has disadvantages, however, in terms of the required installation space if a large binding element loop is to be produced. The detection element can, for example, therefore be adjusted translationally in order to deflect the binding element strand. This embodiment can, for example, be combined with the above-mentioned embodiment in which the deflection direction runs at least approximately parallel to the pressing axis. The detection element can, for example, be adjusted in a linear translatory manner so that the deflection direction is constant.

One embodiment of the present invention provides that the deflection drive has at least one linear actuator which can, for example, be designed as a hydraulic cylinder. A pneumatic cylinder or an electric linear actuator can, for example, alternatively also be used. A linear spring, for example, a coil spring, would also be conceivable. The deflection drive can, for example, have two linear actuators. These can be arranged offset relative to the transverse axis, for example, on both sides of the centerline of the baler. The at least one linear actuator can in particular be directly coupled to at least one deflection device. In the case of a constant deflection direction, the linear actuator can be advantageously aligned parallel to this deflection.

Another possibility is that the deflection drive is designed as a rack-and-pinion drive, with a rack coupled to the at least one detection element in a force-transmitting manner. The rack is mounted so that it can be moved translatorily, for example, on the main frame. The rack is driven by a gearwheel. The movement of the rack is transmitted to at least one detection element. The direction of displacement of the rack can, for example, be identical to the deflection direction.

In an embodiment of the present invention, the deflection device can, for example, be designed to grasp the binding element strand at the front relative to the longitudinal axis and deflect it to the rear. This means that the detection element is arranged in front of the binding element strand relative to the longitudinal axis and is then moved to the rear. The binding element strand is deflected to the rear relative to the longitudinal axis, and the deflection direction points to the rear, although not necessarily parallel to the longitudinal axis or the pressing axis. The detection element thus moves in the same direction as the crop bale being formed relative to the longitudinal axis. This in turn has decisive advantages with regard to the load on the binding element strand. If, for example, the press piston acts on the crop bale while the binding element loop is still being produced, this leads to a force peak that increases the frictional force on the binding element strand. At the same time, however, the pressure exerted by the press piston also causes both crop bales to move to the rear. This means that during the time interval in which the frictional force briefly increases, the crop bales move at least proportionally in the deflection direction, causing the binding element loop to briefly relax. It is therefore unlikely that the increased frictional force will lead to an increased load on the binding element strand. Although this effect is desirable, the average movement speed of the crop bale, i.e., the speed at which the crop bale grows, should be slower than the speed of the detection element. If the directions of movement are not parallel, this statement applies to the component of the speed of the detection element that runs parallel to the pressing axis.

The binding arrangement can, for example, be designed to adjust the deflection device from the standby position to the deflection position while a plurality of movement cycles of a press piston arranged in the pressing channel are performed. The press piston moves in a known oscillating manner in the pressing channel, wherein a period of movement is referred to here as a movement cycle. The adjustment of the deflection device into the deflection position, and thus the formation of the binding element loop, takes place during several movement cycles. This means that the binding element loop is built up comparatively slowly, thus avoiding excessive tensile forces acting on the binding element strand. This embodiment can in particular be combined with the one described above in which the binding element strand is deflected to the rear.

An embodiment of the present invention provides that the binding arrangement is designed so that, after the binding needles have been moved back through the pressing channel, the binding element strand extends from the front holding unit forwards relative to the longitudinal axis to the pressing channel, where it rests against the front of a completed crop bale. This course of the binding element strand is achieved primarily by a suitable arrangement of the front holding device. The most recently completed crop bale forms a contact surface for the binding element strand at the rear. The binding element strand therefore extends within the pressing channel at the front of the crop bale. The crop bale does not form a corresponding contact surface above the pressing channel. The binding element strand there extends forwards from the front holding unit relative to the longitudinal axis. In other words, the front holding unit is arranged further to the rear than the front of the finished crop bale. The binding element strand accordingly does not run along the shortest path, but diagonally towards the pressing channel. This refers to the state immediately after the binding needles have been moved back through the pressing channel and have thus again completely released the pressing channel. The binding element strand is then detected by the detection element. Until then, or shortly after detection, the binding tension can be delimited by the embodiment described here. Since the already completed crop bale moves to the rear when the next crop bale is formed, this also applies to the adjacent part of the binding element strand. This moves to the rear relative to the longitudinal axis, which initially shortens the distance to the front holding unit and relaxes the part of the binding element strand located above the pressing channel.

In an embodiment of the present invention, the deflection device is designed to guide a second holding section of the binding element strand to a rear holding device when adjusted to the deflection position, wherein the binding arrangement is designed to then hold the second holding section with the rear holding device. The rear holding device is arranged behind the front holding device relative to the longitudinal axis. Although the present invention is not limited thereto, a middle holding arrangement can be provided between the front holding arrangement and the rear holding arrangement to which a friction welding unit can be assigned. It is known in prior art balers that a binding element strand is held in place by the rear holding unit when it is released from the front holding unit before welding. The rear holding unit can, however, be closed at the earliest once the crop bale has reached the position of the rear holding unit relative to the longitudinal axis. This is different with this embodiment since the binding element loop can move to the rear faster than the crop bale. The rear holding unit can therefore detect the second holding section of the binding element strand at an earlier point in time. This can in particular happen before the detection element reaches the deflection position. The holding force required for the binding element strand can therefore be distributed between the front and rear holding units already during the formation of the binding element loop. This also applies if the binding element loop is used up during bale formation and additional binding material must be pulled through the area between the crop bales. The binding arrangement can control the rear holding unit in particular depending on a position of the deflection device. This position can, for example, be detected via a sensor.

In an embodiment of the present invention, the deflection device can be designed to grasp the binding element strand at the rear relative to the longitudinal axis and to deflect the binding element strand to the front. This means that the detection element is arranged behind the binding element strand relative to the longitudinal axis and is then moved to the front. The binding element strand is deflected to the front relative to the longitudinal axis and the deflection direction points to the front. The detection element thus moves in the opposite direction to the crop bale being formed relative to the longitudinal axis.

Different options exist for transmitting the drive to the detection element. One embodiment provides that the detection element is fastened to a flexible carrier belt which is guided by a plurality of guide rollers. The carrier belt can be closed all the way around. It can be designed to be flexible overall or consist of a plurality of movably connected members. The carrier belt is guided over a plurality of guide rollers, wherein a change of direction is possible at each guide roller. The deflection direction of the detection element can also change there. The carrier belt can be closed. The carrier belt can be coupled directly or indirectly to the deflection drive, for example, in that one of the guide rollers is designed as a drive roller and can be driven via the deflection drive. A deflection element can be assigned to at least one guide roller via which the binding element strand can be deflected between the front holding unit and the detection element. Such a deflection element allows the binding element strand to follow the changing deflection direction. The binding element strand would otherwise extend in a straight line between the front holding unit and the detection element. The deflection can increase the length of the binding element loop without correspondingly increasing its extension along one of the axes. This means that the space required to produce a binding element loop of a certain length can be minimized.

The deflection device can, for example, have at least one connecting part via which at least one detection element is connected in a force-transmitting manner at least indirectly to the deflection drive, wherein the connecting part is designed to transmit a tensile force and/or a compressive force from the deflection drive to the detection element. The connecting part can be flexible or even bendably slack in some embodiments. In the latter case, the connecting part can only serve to transmit a tensile force which may be disadvantageous under certain circumstances. The connecting part can, for example, be designed as a rigid connecting part. It can run at least in sections, in particular continuously, parallel to the deflection direction. The connecting part can, for example, be designed to transmit a tensile force (i.e., to pull the detection element) when moving from the standby position to the deflection position and to transmit a compressive force (i.e., to pull the detection element) when returning to the standby position. The connecting part can in this case extend from the detection element in the deflection direction. A compressive force can alternatively be transmitted during adjustment and a tensile force during reset, wherein the connecting part can extend from the detection element in the opposite direction to the deflection direction. Each connecting part can, for example, be connected to exactly one detection element. Each detection element can, for example, be connected to two connecting parts, which can in particular be spaced apart along the transverse axis. The binding element strand can pass through the space between the connecting parts. The connecting parts can have guide surfaces facing the space which can run at least in sections at an angle to the vertical axis and/or the longitudinal axis. These guide surfaces serve to prevent an unwanted lateral deviation of the binding element strand.

Relative to the transverse axis, a passage area is advantageously designed next to at least one connecting part via which the binding needle can be passed when the deflection device is in the standby position and whose position relative to the transverse axis intersects with that of the associated detection element. The passage area can be formed between two connecting parts relative to the transverse axis, wherein it can be identical to the above-mentioned space. The passage area is arranged next to the side of the connecting part relative to the transverse axis if only one connecting part is assigned to a detection element. The position of the detection element relative to the transverse axis intersects with that of the passage area, however, this being necessary for the detection element to detect the binding element strand guided by the binding needle.

In an embodiment of the present invention, the binding arrangement is designed to trigger the adjustment of the deflection device into the deflection position depending on the position of the needle swing. Thereby, either the position of the needle swing can be used directly or a position of another element from which the position of the needle swing directly results. The position of a crank that is mechanically coupled to the needle swing can be monitored, for example, via a sensor. Adjustment depending on the position of the needle swing in any case enables optimal timing. During the binding cycle, the needle swing emerges upwards from the pressing channel, transfers the binding element strand, which is held in place by the front holding unit as described, and then dives back into and finally under the pressing channel. In order for the deflection device to be adjusted into the deflection position, it is necessary in most embodiments that the binding needle has at least been submerged again in the pressing channel. It can also be necessary for the binding loop of the just completed crop bale to be closed, for example, by welding the ends of the belt, before the deflection device is adjusted. As already mentioned above, the binding element loop can, for example, be released by returning it to the standby position. The binding arrangement can in this case be set up to detect when the deflection position has been reached and then trigger a return to the standby position.

In an embodiment of the present invention, the deflection device has a deflection frame which is coupled to the deflection drive in a drive-transmitting manner and is guided on the main frame, as well as a plurality of detection elements connected to the deflection frame via connecting parts. All detection elements can, for example, be connected to a single deflection frame. The deflection frame can, for example, extend along the transverse axis over at least a major part of the width of the pressing channel. A plurality of connecting parts extend from the deflection frame, which can itself be rigidly designed, to the detection elements. Two connecting parts can in particular be provided per detection element. The deflection frame is guided by the main frame, which is highly stable overall and undergoes only minimal deformation during operation. The main frame can have an element specifically designed to guide the deflection frame, for example, a guide rail, a guide roller, or similar. The deflection frame can, for example, be guided parallel to the deflection direction. A double roller guide can in particular be provided, wherein two respective guide rollers arranged on the deflection frame interact with a guide rail on the main frame. The two guide rollers, which are offset from each other along the deflection direction, can prevent the deflection frame from rotating relative to the main frame.

It is advantageous that the connecting parts are guided independently of the deflection frame on a knotter table arranged above the pressing channel and are movably connected to the deflection frame. The knotter table forms an upper end to the pressing channel in one area. The above-mentioned knotter shaft or control shaft can be rotatably mounted on the knotter table. The holding units can either be connected directly to the knotter table or to the knotter shaft (and thus indirectly to the knotter table). The knotter table is itself connected to the main frame. The knotter table has, however, greater elasticity than the main frame for structural reasons. This means that deformations of the knotter table may occur during operation that cannot be neglected. If the connecting parts are therefore guided on the knotter table while the deflection frame is guided on the main frame, this can lead to changes in position between the deflection frame and the connecting parts. These could be compensated for, for example, by elastic deformation of a connecting part, however, this would carry the risk of the connecting part tilting relative to the knotter table or, at the very least, significantly increasing friction. This embodiment therefore provides for the connecting parts to be movably connected to the deflection frame. At least one rotational and/or translational degree of freedom can be provided. The connecting parts can in particular be movable along the vertical axis since this is the most common direction of deformation of the knotter table. The deflection frame itself can be arranged behind the holding units relative to the longitudinal axis, both in the standby position and in the deflection position, while the positions of the connecting parts relative to the longitudinal axis can intersect with positions of the above-mentioned holding units, at least in the standby position. The connecting parts and the detection elements can, for example, be arranged below the holding units relative to the vertical axis. They can thus move beneath the holding units without impairing their function.

It can be problematic to maintain the guide of a connecting part over the entire adjustment range when the standby position and the deflection position are in particular far apart. This applies at the latest when the adjustment range is longer than the knotter table. This problem is solved in an embodiment by at least one connecting part protruding beyond the detection element in the opposite direction to the deflection direction, whereby in the deflection position it is guided by a guide area which is spaced apart from the detection element in the opposite direction to the deflection direction on the knotter table. If the deflection direction points to the rear and the connecting part extends to the rear from the detection element to exert a tensile force, this embodiment provides, for example, for it to also extend to the front. This part of the connecting part is not used to transmit tensile force but to maintain contact with the knotter table. Even if, for example, the detection element has left the knotter table to the rear, the guide area can still remain in contact with the knotter table and provide reliable guide.

The present invention also provides a method for operating a baler with a pressing channel in which crop bales can be conveyed from front to rear along a pressing axis relative to a longitudinal axis, and with a binding arrangement comprising a needle swing with a plurality of binding needles arranged offset relative to each other with respect to a transverse axis, at least one front holding unit, and at least one deflection device. In this method:
each binding needle guides a binding element strand upwards through the pressing channel relative to a vertical axis,
at least one front holding unit holds a first holding section of a binding element strand guided upwards through the pressing channel by a binding needle, and
the deflection device is adjusted by a deflection drive from a standby position into a deflection position, whereby at least one detection element of the deflection device, which is movable relative to the front holding unit, is moved at least partially along the pressing axis and at least one binding element strand is detected by the detection element at a distance from the first holding section and deflected relative to the front holding unit, so that the binding element strand is drawn through the pressing channel and a binding element loop is produced which runs from the front holding unit via the detection element and has a change of direction relative to the pressing axis at the detection element.

The terms mentioned above have already been explained with reference to the baler according to the present invention and will therefore not be explained again. Advantageous embodiments of the method according to the present invention correspond to those of the baler according to the present invention.

The present invention is described in greater detail below with reference to drawings. The drawings are merely examples and do not thereby limit the general scope of the present invention.

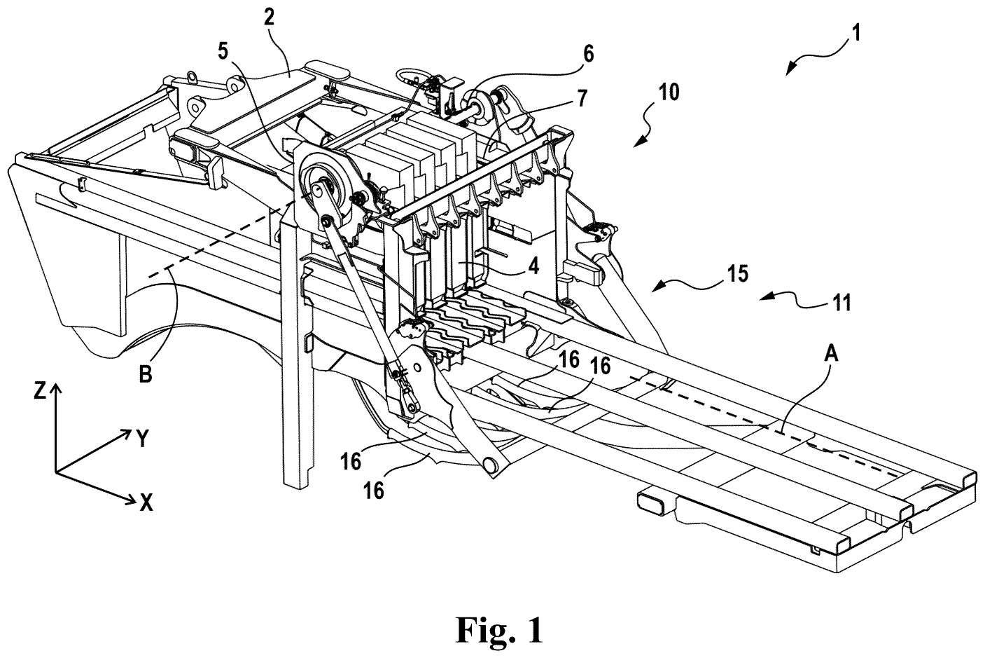

FIG. 1 shows a perspective illustration of parts of a baler 1 according to the present invention, more precisely a square baler. Here and in the other drawings, the longitudinal axis X, the transverse axis Y, and the vertical axis Z are shown pointing to the rear in the opposite direction of travel. Different components that are not relevant to understanding the present invention are not shown, for example, a chassis and a drawbar via which the baler 1 can be coupled to a towing vehicle. The present invention is expressly not limited to towed or carried balers but also relates to self-propelled balers or stationary balers.

The baler 1 has a main frame 2. A pressing channel 11 is defined within the main frame 2 which extends along a pressing axis A. In this example, the pressing axis A is inclined relative to the longitudinal axis X, but it could also run parallel thereto. The side and upper cladding of the pressing channel 11 is partially omitted in the drawing.

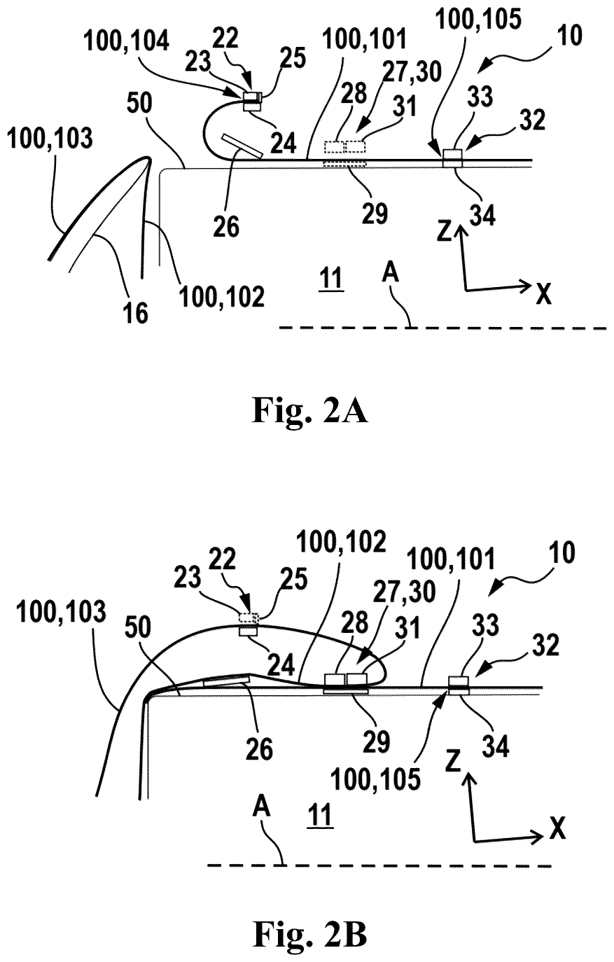

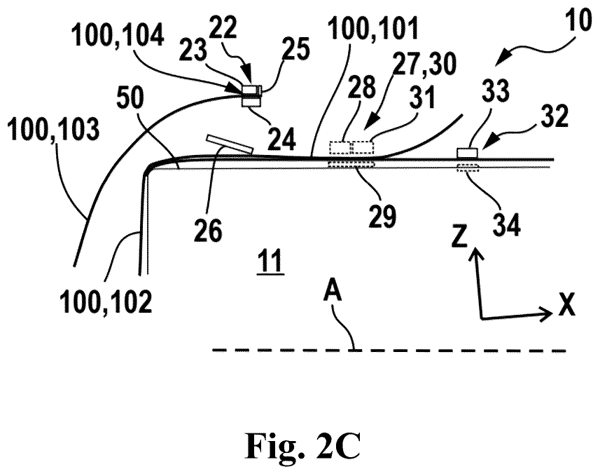

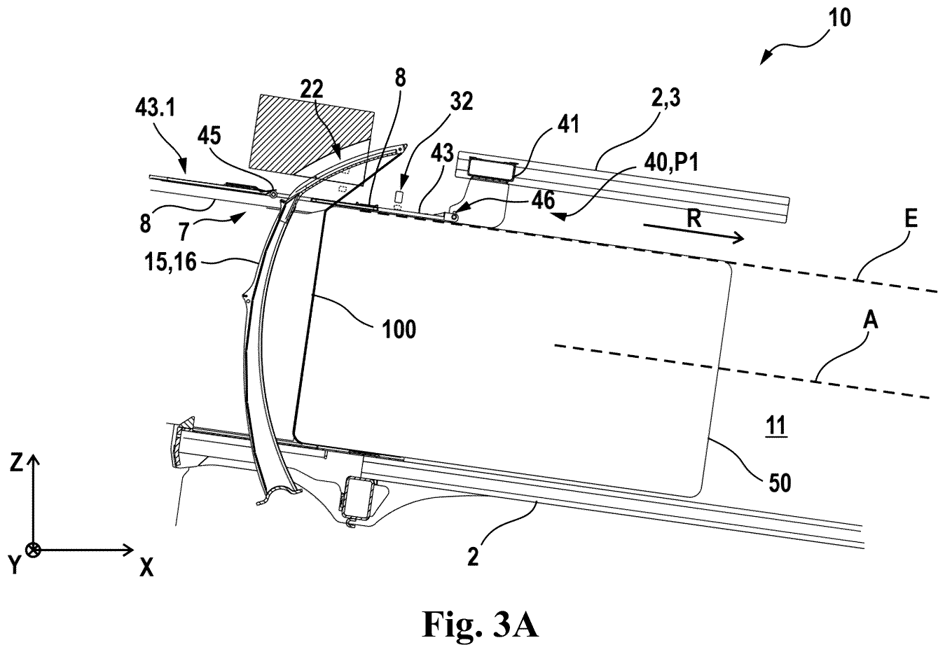

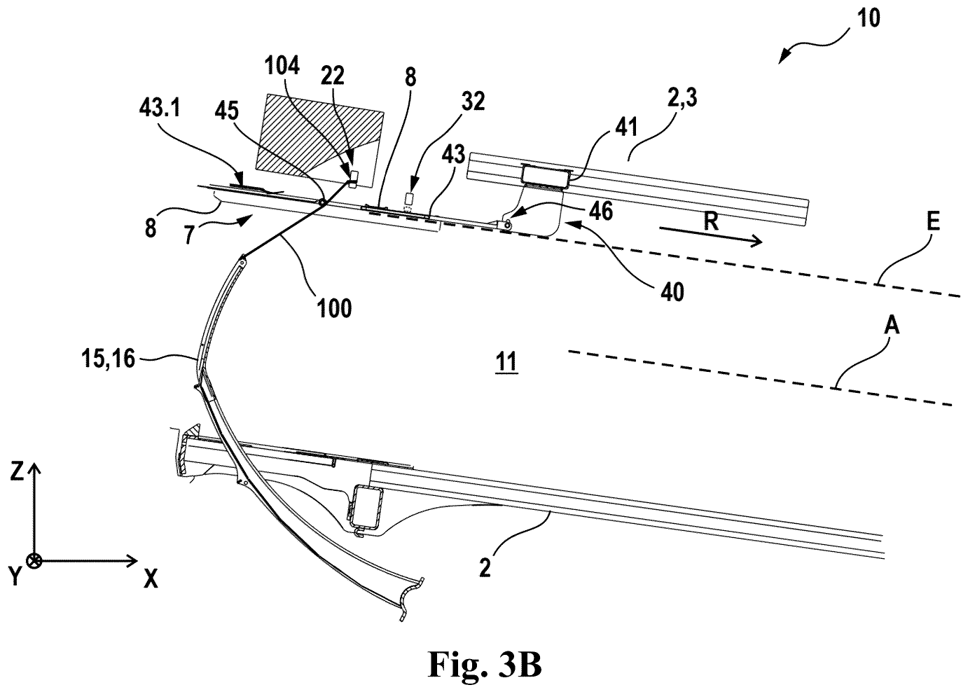

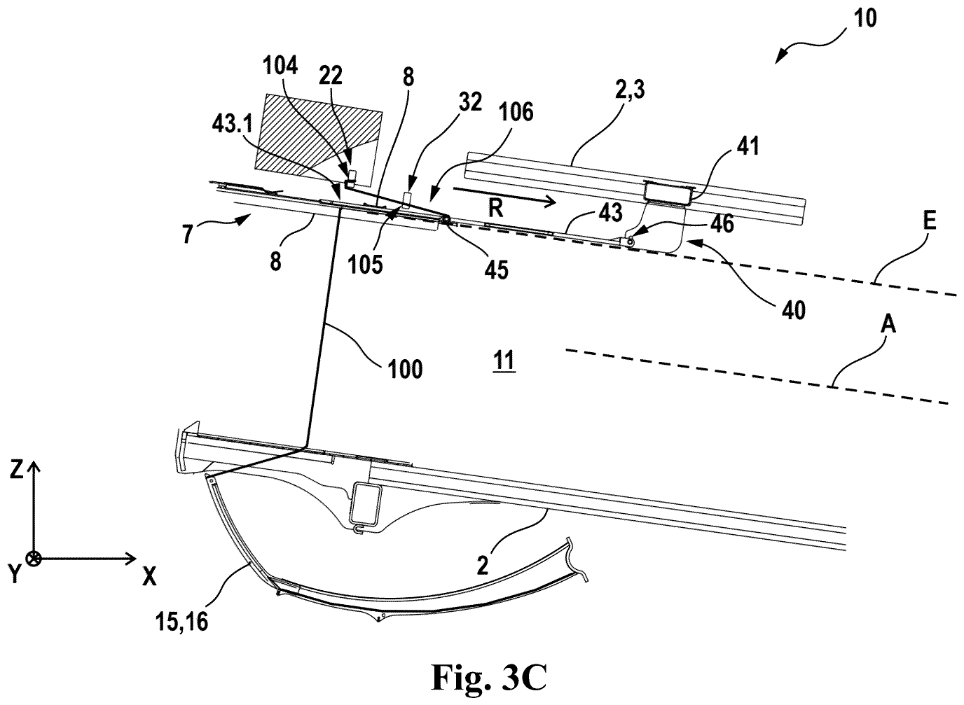

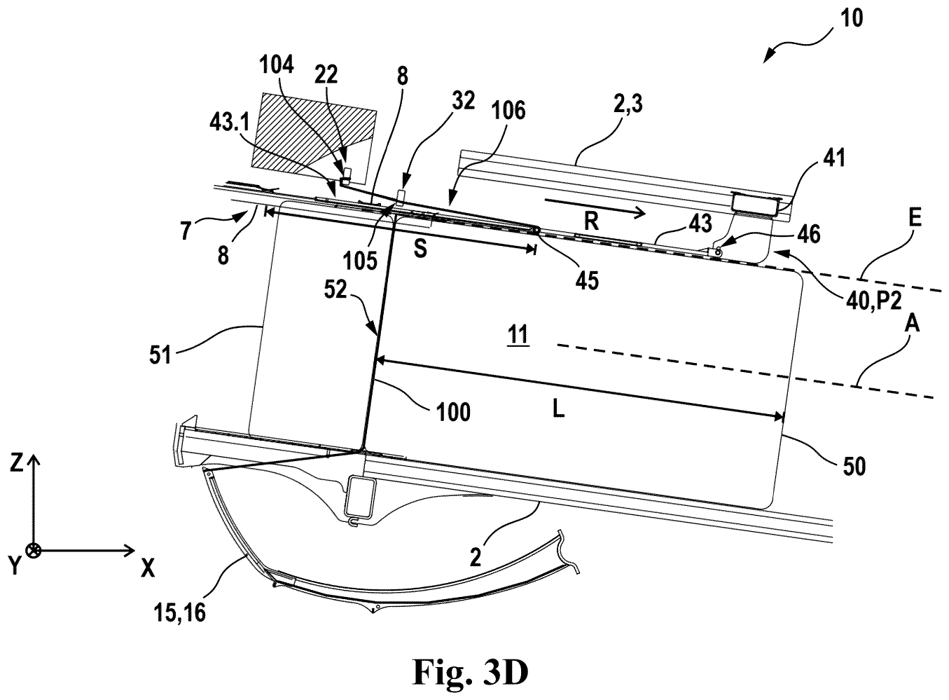

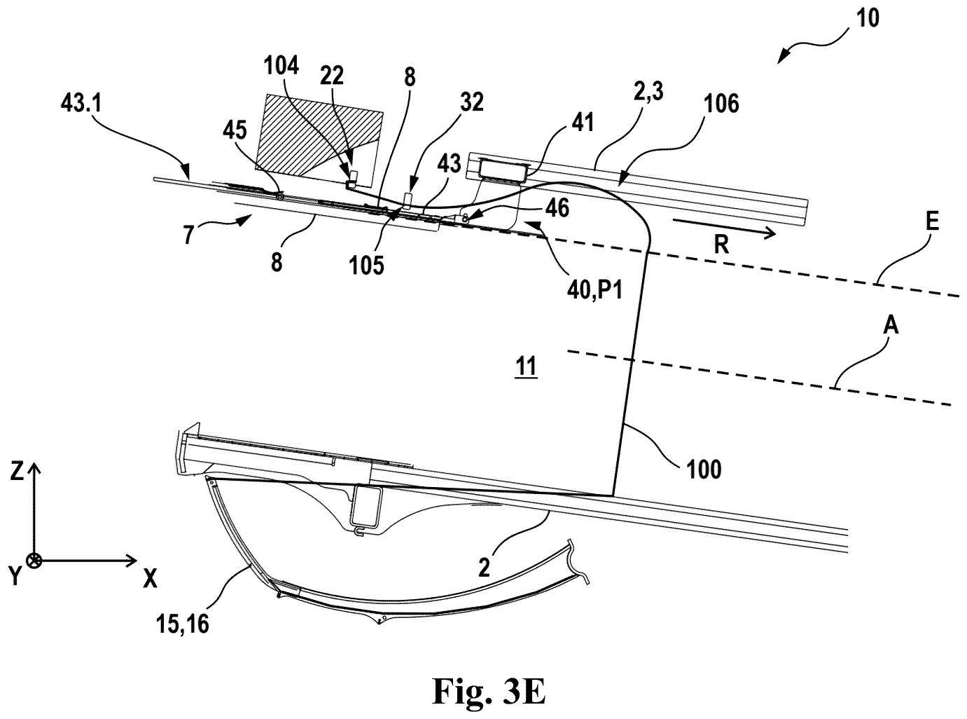

Within the pressing channel 11, crop bales 50, 51 (shown schematically in FIGS. 2A to 2C and FIGS. 3A and 3D), in particular square bales, are successively built up from portions of crop that have been collected, in particular pre-pressed, in a collecting chamber (not visible here). The crop conveyed from the collecting chamber into pressing channel 11 is compacted in pressing channel 11 by an oscillating press piston 4. When the crop bale 50 has reached its predetermined size, it is tied together via a binding element, more specifically, a thermoplastic band. In the baler 1 shown here as an example, a total of six loops of binding element, which are spaced apart in the direction of the transverse axis Y and thus transversely to the pressing axis A, are placed around the crop bale 50. The binding element of the respective loop leads to the rear on the upper side of the crop bale 50 relative to the longitudinal axis X, then downwards on its underside relative to the vertical axis Z, forwards on the underside, and upwards on the front side. To complete the loop, a binding element strand 100 must be fed upwards from below through the pressing channel 11. This is done via each one of a total of six binding needles 16, which are part of a needle swing 15. The needle swing 15 is connected to a knotter shaft or control shaft 6 in a manner not explained in detail here and can be driven thereby. The control shaft 6 can be connected to a motor drive (not shown) via a coupling gear 5 so that it rotates around a control shaft axis B and drives the needle swing 15 for a binding cycle.

The needle swing 15 belongs to a binding arrangement 10 of the baler 1. The binding arrangement 10 also has a front holding unit 22, a middle holding unit 27, and a rear holding unit 32 for each binding element strand 100, as shown in FIGS. 2A-2C and FIGS. 3A-3E. A separating element 25 is assigned to the front holding unit 22 and a welding unit 30 is assigned to the middle holding unit 27. A hold-down device 26 is also provided for each binding element strand 100. The function of the individual elements is explained below using FIGS. 2A to 2C.

FIG. 2A represents a state shortly before completion of the crop bale 50, while a final layer of crop is added by the press piston 4 (not shown here). A first strand section 101, which forms an end section of the binding element strand 100, lies on the upper side of the crop bale 50 and is held at the end by a first holding section 104 between a first front clamping element 23 and a second front clamping element 24 of the front holding unit 22. The separating element 25 is rigidly coupled to the first front clamping element 23. The hold-down device 26 is inactive and may have only slight or no contact with the first strand section 101. A first middle clamping element 28 and a second middle clamping element 29 of the middle holding unit 27, as well as a friction head carrier 31 of the welding unit 30, are pivoted out of the drawing plane. Elements positioned outside the drawing plane in this way are each shown here and in FIGS. 2B and 2C by dashed lines. A sensor (not shown here) determined that only one more layer must be added to crop bale 50 in order for it to reach a specified target size. A friction head carrier 31 of the welding unit 30 was then started even before the control shaft 6 is connected to the motor drive via the coupling gear 5. The rear holding unit 32 has also already been closed, so that the first strand section 101 is enclosed with a second holding section 105 between a first rear clamping element 33 and a second rear clamping element 34. The binding needle 16 guides a second strand section 102 of the same binding element strand 100 and a third strand section 103 connected thereto upwards through the pressing channel 11.

FIG. 2B represents a state in which the binding needle 16 has deposited the second strand section 102 on the first strand section 101. The front clamping elements 23, 24, and the separating element 25 have been rotated out of the drawing plane to make room for the binding needle 16. Since the first strand section 101 is clamped via the rear holding unit 32, it is prevented from shifting or being completely lost. The hold-down device 26 was adjusted so that it pressed down on the first strand section 101 from above and prevented it from protruding into the path of movement of the binding needle 16. The first middle clamping element 28 and the friction head carrier 31 are pivoted into the drawing plane and enclose the first strand section 101 between themselves and the second middle clamping element 29. The second front clamping element 24 is then pivoted back into the drawing plane. By activating a friction head arranged on the friction head carrier 31, the first strand section 101 and the second strand section 102 are frictionwelded.

The rear holding unit 32 can now be released, wherein the first rear clamping element 33 is stationary in this case and thus remains in the drawing plane. The hold-down device 26 is also released from the first strand section 101, wherein it is moved out between this and the second strand section 102. The front holding unit 22 grasps the third strand section 103 connected to the second strand section 102 and the separating element 25 separates the second strand section 102 therefrom. This state is shown in FIG. 2C. After the strand sections 101, 102 have been welded, the middle holding unit 27, including the friction head carrier 31, can be released and moved out of the drawing plane. The now completely strapped crop bale 50 can be conveyed to the rear, wherein it is successively pushed backwards along the pressing direction A by a subsequent crop bale 51 that is being formed. The third strand section 103 grasped by the front holding unit 22 takes over the role of the first strand section 101 in the next binding cycle.

The drawings show a contact area 52 in which the successive crop bales 50, 51 are immediately adjacent to each other, wherein they are partially in direct contact with each other and partially enclose the binding element strand 100 between them. When forming the new crop bale 51, more binding element is gradually required at its upper side since the contact area 52 is moving away successively from the front holding unit 22, which holds the first holding section 104. Pulling the binding element through the contact area 52 can, however, lead to considerable stress, since the crop bales 50, 51 are pressed against each other by the press piston 4, which in turn leads to considerable frictional forces between the binding element strand 100 and the crop bales 50, 51.

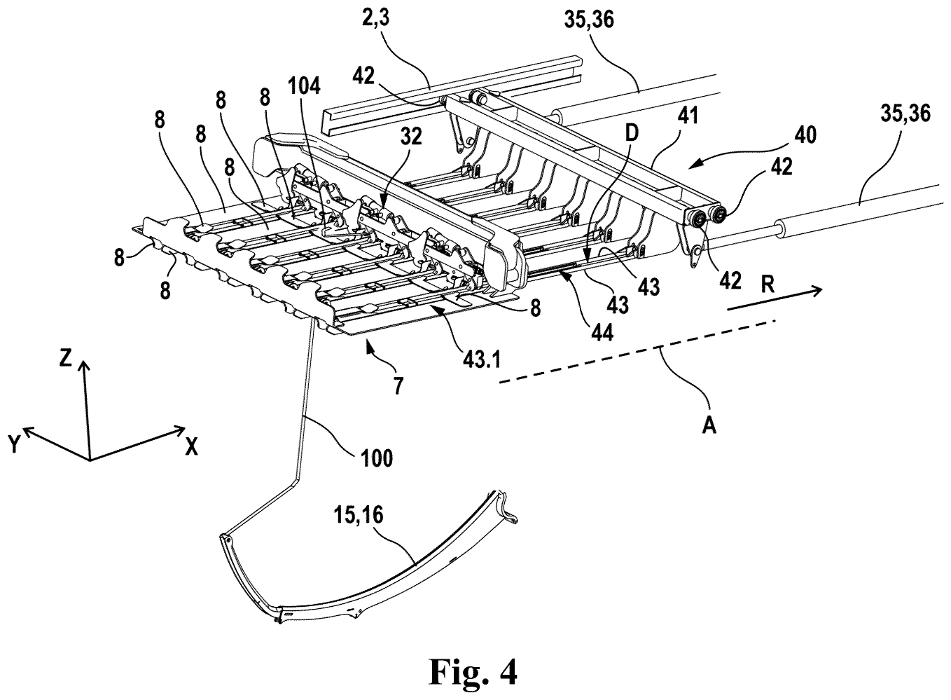

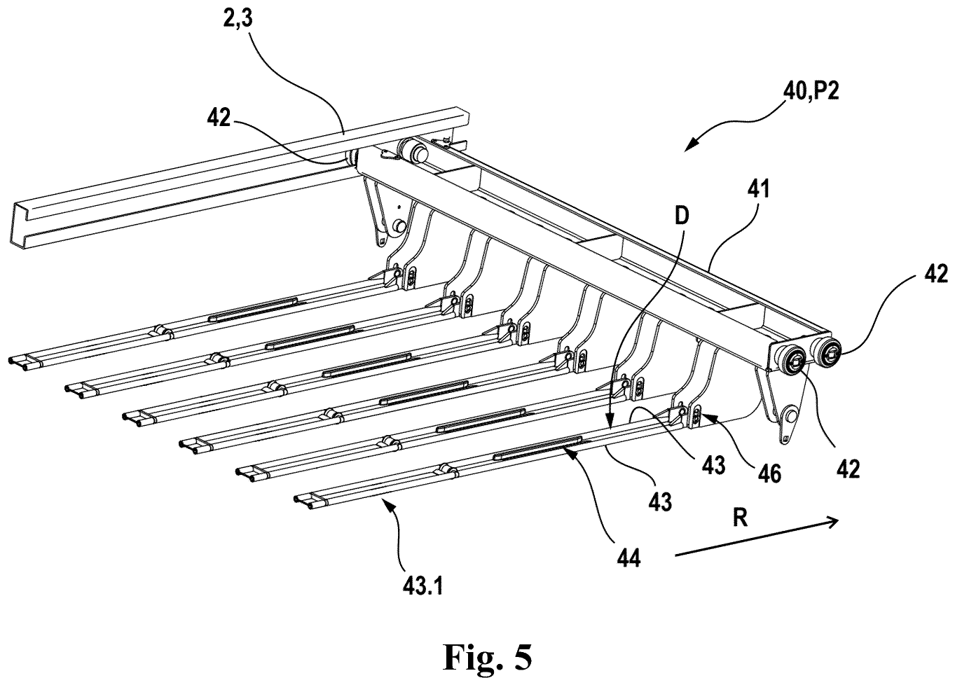

To minimize this problem, the binding arrangement 10 is designed to apply a binding element loop 106 which can be gradually used up during bale formation. Important for the construction of the binding element loop 106 is a deflection device 40 which acts on a binding element strand 100 via a respective detection element 45. This process is explained below with reference to FIGS. 3A-3E and with reference to FIGS. 4 and 5, in which the deflection device 40 can be seen in detail. In FIGS. 1 and 2A-2C, the deflection device 40 has been omitted for reasons of clarity. The respective detection element 45 and also the deflection device 40 as a whole can be displaced in a deflection direction R relative to the main frame 2. The deflection direction R in this case runs parallel to the pressing axis A. A deflection frame 41 extends along the transverse axis Y across the entire width of the pressing channel 11. The deflection frame 41 is guided on both sides by two respective guide rollers 42 on a guide rail 3 of the main frame 2, which is designed here as a C-profile. A linear actuator 36 designed as a hydraulic cylinder engages with the respective deflection frame 41 approximately perpendicular below each of the guide rollers 42. The linear actuators 36 are connected to the main frame 2 (in a manner not shown here) and together form a deflection drive 35.

A total of twelve rod-shaped connecting parts 43 are connected to the deflection frame 41, two of which connect a respective detection element 45 to the deflection frame 41. The roller-shaped detection element 45 is rotatably mounted on the respective two connecting parts 43. A passage area D is formed between the connecting parts 43, which is open in the deflection direction R, i.e., to the rear. The connecting parts 43 have respective guide surfaces 44 for the binding element strand 100 at the passage area D. An extension section 43.1 of each connecting part 43 projects beyond the detection element 45 in the opposite direction to the deflection direction R. The connecting parts 43 are guided independently of the deflection frame 41 on a knotter table 7 which extends above the pressing channel 11. The knotter table 7 has guide elements 8 which serve to guide the connecting parts 43 in a movable manner. The extension section 43.1 can maintain the guide even if the deflection device 40 moves far to the rear in the deflection direction R. The knotter table 7 is connected to the main frame 2, but deforms elastically during operation, which is why the guide elements 8 can also move relative to the guide rails 3. To take this into account, the connecting parts 43 are movably connected to the deflection frame 41 by short coulisse guides 46. This allows them to move slightly in the direction of the vertical axis Z relative to the deflection frame 41. There is a positionally fixed connection in deflection direction R except for unavoidable play.

For reasons of clarity, the crop bales 50, 51 and the contact area 52 between them are omitted in FIGS. 3B, 3C and 3E and are only shown in FIGS. 3A and 3D. The separating element 25, the hold-down device 26, and the middle holding unit 27, are also not shown in FIGS. 3A-3E. FIG. 3A shows a state which lies between FIGS. 2A and 2B in terms of time, i.e., a completed crop bale 50 has been completed and the binding needles 16 have guided the binding element strand 100 upwards to such an extent that it can be taken over by the middle holding unit 27. The binding needles 16 begin their downward movement, but are still partially above a knotter table plane E defined by the knotter table 7, which runs parallel to the pressing axis A and runs close above the pressing channel 11. The deflection drive 35 is inactive and the deflection device 40 with the detection elements 45 is in a standby position P1. The respective binding needle 16 is guided through the passage area D between two connecting parts 43.

FIG. 3B shows a state occurring after FIG. 2C. The binding needle 16 moves downwards and is completely below the knotter table plane E, wherein the position of the needle swing 15 is detected by sensors. The deflection drive 35 is then activated so that the deflection device 40 moves to the rear in the deflection direction R. The detection element 45 does not yet come into contact with the binding element strand 100 on the first part of the path. The latter rather still moves within the passage area D. In FIG. 3B, the detection element 45 is just in contact with the binding element strand 100.

In FIG. 3C, the needle swing 15 has returned to its starting position below the pressing channel 11. The detection element 45 has begun to deflect the binding element strand 100 to the rear to form the binding element loop 106, wherein the connecting parts 43 transmit a tensile force to the detection element 45. The rear holding unit 32, which was previously open, can therefore grip the binding element strand 100 in the second holding section 105. The closing of the rear holding unit 32 is triggered depending on the sensor-detected position of the deflection device 40. The binding element strand 100 is subsequently held by the front holding unit 22 and the rear holding unit 32 so that the necessary holding force is distributed between both holding units 22, 32. The press piston 4 has in the meantime already compacted one or a plurality of layers of the next crop bale 51 in the pressing channel 11. As the deflection device 40 continues to move, the binding element loop 106 grows above the pressing channel 11 and above the already completed preceding crop bale 50. The detection element 45 has already moved to the rear beyond the knotter table 7, wherein the extension section 43.1 is, however, furthermore in engagement with the guide elements 8. The entire adjustment process of the deflection device 40 extends over a plurality of movement cycles of the press piston 4, i.e., the press piston 4 acts intermittently on the newly formed crop bale 51, causing the contact pressure between the crop bales 50, 51 and also the friction of the binding element strand 100 increase abruptly. However, when the press piston 4 acts, the new crop bale 51 and the part of the binding element strand 100 located in the contact area 52 also move to the rear, i.e., in the deflection direction R. This prevents excessive tension from building up in the binding element strand 100.

FIG. 3D shows a state in which the deflection device 40 has reached its rearmost position, which corresponds to a deflection position P2. The binding element strand 100 is held on both sides of the binding element loop 106, on the one hand by the rear holding unit 32, and on the other hand in the contact area 52, by the clamping force between the crop bales 50, 51. The binding element loop 106 has a change of direction relative to the pressing axis A at the detection element 45. Starting from the front holding unit 22, the binding element strand 100 runs to the rear to the detection element 45 and then forwards to the contact area 52. Two loop sections can thus be seen, superimposed on each other relative to the vertical axis Z and running in opposite directions relative to the pressing axis A. In this example, the maximum total length of the binding element loop visible in FIG. 3D is approximately 90% of the length L of the completed crop bale 50. In this example, the deflection distance S traveled by the detection element 45 between the standby position P1 and the deflection position P2 corresponds to approximately 60% of the length L. Reaching the deflection position P2 is also detected by sensors. When this happens, the linear actuators 36 of the deflection drive 35 are stopped and immediately driven in the opposite direction, i.e., extended. This causes the deflection device 40 to move forwards.

In FIG. 3E, the detection elements 45 of the deflection device 40 have again reached the standby position P1. The binding element strand 100 is furthermore held by the front holding unit 22 and the rear holding unit 32. Due to the binding element loop 106, no more binding element needs to be pulled through the contact area 52 until further notice. The binding element loop 106 is gradually used up. Either the new crop bale 51 has reached its intended size by then, so that the binding process can be triggered, or the crop bale 51 is alternatively not yet completed, but is, however, already large enough that the action of the press piston 4 does not cause an excessive increase in the force between the crop bales 50 and 51, so that binding elements can be added without any major problems.

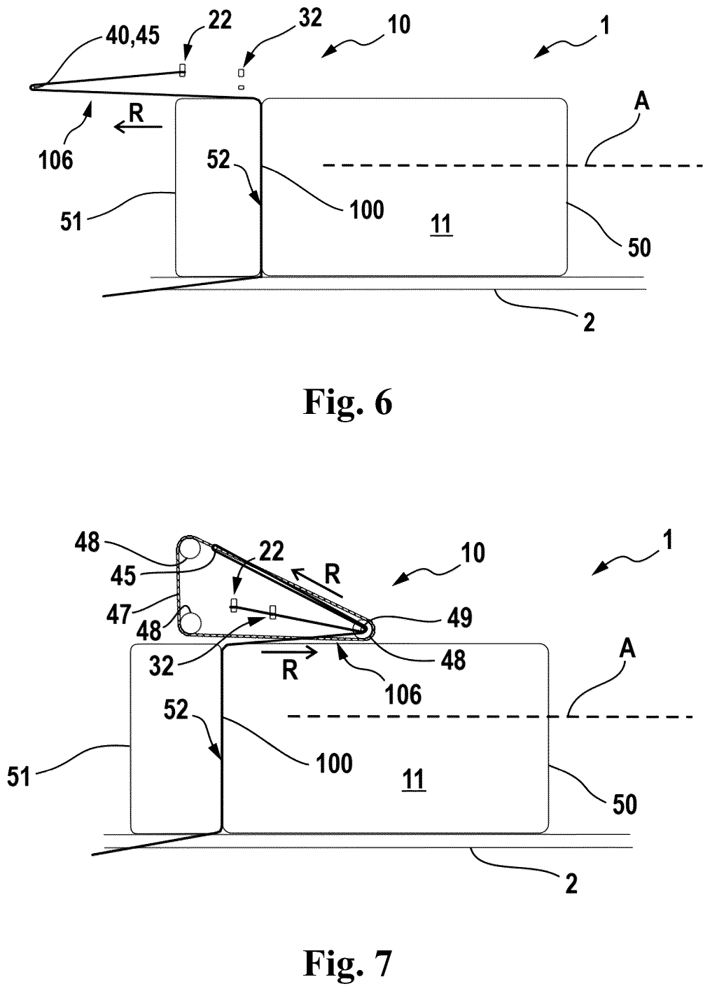

FIG. 6 shows, in a highly schematic form, a second embodiment of a baler 1 according to the present invention with a binding arrangement 10. While the deflection device 40 in the first embodiment engages the binding element strand 100 at the front and deflects it to the rear, in this embodiment the deflection device 40 engages the binding element strand 100 at the rear and deflects it forwards. This means that the deflection direction R points forwards. The deflection drive 35 (which is not shown) can also have one or a plurality of linear actuators in this embodiment.

FIG. 7 shows a third embodiment in which the deflection device 40 has a self-contained, flexible carrier belt 47 which is guided over a total of three guide rollers 48. One of the guide rollers 48 is designed as a drive roller and is connected to the deflection drive 35 in a manner not shown. The carrier belt 47 can be driven circumferentially by rotating the driven guide roller 48. The detection element 45 is attached to the carrier belt and follows its movement. It is therefore first pulled to the rear roughly parallel to the pressing axis A and then diagonally upwards to the front. To provide that the binding element loop 106 approximately follows the course of the carrier belt 47, a guide roller 48 is assigned a deflector element 49, over which the binding element strand 100 is guided. The binding element loop 106 in this embodiment has a total of three changes of direction relative to the pressing axis A.

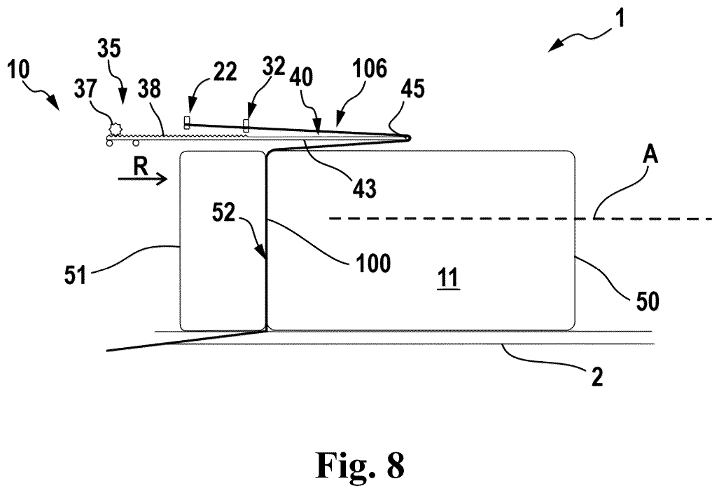

FIG. 8 shows a fourth embodiment in which the deflection device 40 again grasps the binding element strand 100 at the front and deflects it to the rear. In this case, however, the deflection drive 35 is designed as a rack-and-pinion drive, with a driven gearwheel 37 and a rack 38 that interacts therewith. The rack 38 is formed integrally with a connecting part 43 and is thus coupled to the detection element 45. The connecting part 43 in this embodiment transmits a compressive force to the detection element 45. Although the rack-and-pinion drive in this example is arranged in front of the detection element 45 relative to the longitudinal axis X, it would also be possible to arrange it behind the detection element 45, similar to the first embodiment example, wherein the connecting part 43 would transmit a tensile force.

The present invention is not limited to embodiments described herein; reference should be had to the appended claims.

### LIST OF REFERENCE CHARACTERS

1 Baler
2 Main frame
3 Guide rail
4 Press piston
5 Coupling gear
6 Control shaft
7 Knotter table
8 Guide element
10 Binding arrangement
11 Pressing channel
15 Needle swing
16 Binding needle
22 Front holding unit
23 First front clamping element
24 Second front clamping element
25 Separating element
26 Hold-down device
27 Middle holding unit
28 First middle clamping element
29 Second middle clamping element
30 Welding unit
31 Friction head carrier
32 Rear holding unit
33 First rear clamping element
34 Second rear clamping element
35 Deflection drive
36 Linear actuator
37 Driven gearwheel
38 Rack
40 Deflection device
41 Deflection frame
42 Guide roller
43 Connecting part
43.1 Extension section
44 Guide surface
45 Detection element
46 Coulisse guide
47 Carrier belt
48 Guide roller
49 Deflection element
50 Crop bale
51 Crop bale
52 Contact area
100 Binding element strand
101 First strand section
102 Second strand section
103 Third strand section
104 First holding section
105 Second holding section
106 Binding element loop
A Pressing axis
B Control shaft axis
D Passage area
E Knotter table plane
L Length
P1 Standby position
P2 Deflection position
R Deflection direction
S Deflection distance
X Longitudinal axis
Y Transverse axis
Z Vertical axis

What is claimed is:

1-17. (canceled)

18. A baler comprising:
a pressing channel which is configured so that crop bales are conveyable from a front to a rear along a pressing axis relative to a longitudinal axis; and
a binding arrangement comprising,
a needle swing comprising a plurality of binding needles which are arranged offset relative to each other with respect to a transverse axis, each of the plurality of binding needles being configured to guide a respective binding element strand upwards through the pressing channel relative to a vertical axis,
at least one front holding unit which is configured to hold a first holding section of the binding element strand which is guided upwards through the pressing channel by a binding needle of the plurality of binding needles,
a deflection drive, and
at least one deflection device comprising at least one detection element, the at least one deflection device being configured to be adjusted by the deflection drive from a standby position into a deflection position, the at least one detection element being configured to be movable relative to the at least one front holding unit and to be movable at least partially along the pressing axis,
wherein,
at least one binding element strand is arranged to be detectable by the at least one detecting element at a distance from the first holding section, and to be deflected relative to the front holding unit so as to draw the at least one binding element strand through the pressing channel so as to produce a binding element loop which runs from the front holding unit via the detection element, the binding element loop having a change of direction relative to the pressing axis at the at least one detection element.

19. The baler as recited in claim 18, wherein the binding arrangement is configured to release the binding element loop after the binding element loop has been produced by returning the at least one deflection device to the standby position.

20. The baler as recited in claim 18, wherein the binding arrangement is configured to produce the binding element loop so that the binding element loop has a maximum total length which corresponds to at least 20% of a length of a completed crop bale in a direction of the pressing axis.

21. The baler as recited in claim 18, wherein the at least one detection element is further configured to be at least partially movable in a deflection direction which runs at an angle of at most 30° to the pressing axis.

22. The baler as recited in claim 21, wherein the deflection direction runs parallel to the pressing axis.

23. The baler as recited in claim 18, wherein the at least one detection element is further configured to be translationally adjustable so as to deflect the at least one binding element strand.

24. The baler as recited in claim 18, wherein the at least one deflection drive comprises at least one linear actuator.

25. The baler as recited in claim 24, wherein the at least one linear actuator is designed as a hydraulic cylinder.

26. The baler as recited in claim 18, wherein,
the deflection drive is designed as a rack-and-pinion drive which comprises a rack, and
the rack is coupled in a force-transmitting manner to the at least one detection element.

27. The baler as recited in claim 18, wherein the at least one deflection device is further configured to grasp the binding element strand at the front relative to the longitudinal axis and deflect the binding element strand to the rear.

28. The baler as recited in claim 18, further comprising:
a press piston arranged in the pressing channel, the press piston being configured to perform a plurality of movement cycles,
wherein,
the binding arrangement is configured to adjust the at least one deflection device from the standby position to the deflection position while the plurality of movement cycles are performed.

29. The baler as recited in claim 18, wherein,
the binding arrangement further comprises a rear holding device,
the at least one deflection device is configured to guide a second holding section of the binding element strand to the rear holding device when the at least one deflection device is adjusted to the deflection position, and
the binding arrangement is configured to then hold the second holding section with the rear holding device.

30. The baler as recited in claim 18, wherein,
the at least one deflection device further comprises at least one connecting part, and
the at least one connecting part is configured,
to at least indirectly connect the at least one detection element to the deflection drive in a force-transmitting manner, and
to transmit at least one of a tensile force and a compressive force from the deflection drive to the at least one detection element.

31. The baler as recited in claim 30, wherein the binding arrangement further comprises:
a passage area which is arranged, relative to the transverse axis, next to at least one of the at least one connecting part,
the passage area is configured so that the binding needle of the plurality of binding needles can be passed therethrough when the at least one deflection device is in the standby position, and
a position of the passage area, relative to the transverse axis, intersects with that of the at least one detection element associated therewith.

32. The baler as recited in claim 30, further comprising:
a main frame,
wherein,
the at least one deflection device further comprises a deflection frame,
the deflection frame is coupled to the deflection drive in a drive-transmitting manner and is guided on the main frame,
the at least one detection element comprises a plurality of detection elements,
the at least one connecting part comprises a plurality of connecting parts, and
the plurality of detection elements are connected to the deflection frame via the plurality of connecting parts.

33. The baler as recited in claim 32, wherein,
the binding arrangement further comprises a knotter table which is arranged above the pressing channel, and
the plurality of connecting parts are configured to be guided independently of the deflection frame on the knotter table and to be movably connected to the deflection frame.

34. The baler as recited in claim 33, wherein,
the at least one detection element is further configured to be at least partially movable in a deflection direction which runs at an angle of at most 30° to the pressing axis,
each of the plurality of connecting parts comprises an extension section,
at least one of the plurality of connecting parts is arranged to protrude beyond the at least one detection element in an opposite direction to the deflection direction, and
in the deflection position, the at least one of the plurality of connecting parts is guided with the extension section spaced apart from the at least one detection element in an opposite direction to the deflection direction on the knotter table.

35. The baler as recited in claim 18, wherein the binding arrangement is configured to trigger an adjustment of the at least one deflection device into the deflection position depending on a position of the needle swing.

36. A method for operating a baler, the baler comprising:
a pressing channel which is configured so that crop bales are conveyable from a front to a rear along a pressing axis relative to a longitudinal axis; and
a binding arrangement comprising,
a needle swing comprising a plurality of binding needles which are arranged offset relative to each other with respect to a transverse axis, each of the plurality of binding needle being configured to guide a respective binding element strand upwards through the pressing channel relative to a vertical axis,
at least one front holding unit which is configured to hold a first holding section of a binding element strand which is guided upwards through the pressing channel by a binding needle of the plurality of binding needles,
a deflection drive, and
at least one deflection device comprising at least one detection element, the at least one deflection device being configured to be adjusted by the deflection drive from a standby position into a deflection position, the at least one detection element being configured to be movable relative to the at least one front holding unit and to be movable at least partially along the pressing axis,
the method comprising:
adjusting the deflection device via the deflection drive from the standby position into the deflection position;
moving the at least one detection element relative to the front holding unit and at least partially moving the at least one detection element along the pressing axis;
detecting at least one binding element strand via the at least one detection element at a distance from the first holding section and deflected relative to the front holding unit; and
drawing the at least one binding element strand through the pressing channel so as to provide a binding element loop which runs from the front holding unit via the at least one detection element and which has a change of direction relative to the pressing axis at the at least one detection element.
